(19) United States
(12) Patent Application Publication
(10) Pub. No.: US 2026/0287005 A1
(43) Pub. Date: Sep. 24, 2026

(54) Hand Screw Locking Mechanism

(71) Applicant: OnLogic, Inc., South Burlington, VT (US)

(72) Inventors: Frederick KOPFF, Burlington, VT (US); Sam GOOVAERTS, South Burlington, VT (US); John SCHMIDT, Burlington, VT (US)

(21) Appl. No.: 19/472,507

(22) PCT Filed: Apr. 12, 2024
(86) PCT No.: PCT/US2024/024263

§ 371 Date: Oct. 3, 2025

Related U.S. Application Data
(60) Provisional application No. 63/459,025, filed on Apr. 13, 2023.

(51) Int. Cl. F16B 39/10

(52) U.S. Cl. CPC F16B 39/10

(57) ABSTRACT

A hand knob locking mechanism is provided that substantially limits the rotation of a hand knob such that once in a desired position, the locked knob does not rotate out of position. The hand knob locking mechanism includes a hand knob, a threaded member fixedly coupled to the hand knob, and a retaining mechanism including a locking bar. The threaded member is rotatably coupled to the retaining mechanism and the locking bar is releasably engageable with the hand knob such that, when the locking bar is engaged with the hand knob, the hand knob is substantially unable to rotate. The locking bar may include a pair of side bars that are configured to engage with indentations, prongs, and/or ridges on the hand knob. The locking bar may be connected to a support member via tension, and is movable between a locked position and an unlocked position.

### RELATED APPLICATION DATA

This application claims the benefit of priority of U.S. Provisional Patent Application Ser. No. 63/459,025, filed Apr. 13, 2023, and titled “Hand Screw Locking Mechanism”, which is incorporated by reference herein in its entirety.

### FIELD OF THE DISCLOSURE

The present invention generally relates to thumb screw assemblies. In particular, the present invention relates to a Hand Screw Locking Mechanism for wing-bolts, thumb screws, hand knobs, and the like.

### BACKGROUND

Fasteners such as wing-bolts, thumb screws, and hand knobs are routinely used in a variety of applications, for example in applications where the components being fastened together are only intended to be combined on a temporary or intermittent basis, such as with a lawn mower handle, for example, or are used to provide for ready adjustments to the positioning of an item, such as the distance an object is away from a wall, or are used for providing a clamping force, for example to temporarily clamp a monitor mount onto a desk or table.

An example of such a use of a fastener, such as the hand knob 12 shown in FIG. 1, is for a monitor mount. The fastener includes a threaded portion 14 and a thumb screw or knob portion 16. Fastener 12 allows for minute adjustment in height of a monitor (not shown) attached to a monitor mount, for example. While providing an easy adjustment means for a user, the fastener 12 is prone to movement due to vibration, inadvertent handling (if a cord is being plugged into the monitor by the user, for example), or other actions that would cause the fastener 12 to adjust.

### SUMMARY OF THE DISCLOSURE

A hand knob assembly is provided that includes a hand knob, a threaded member fixedly coupled to the hand knob, and a retaining mechanism including a locking bar, wherein the threaded member is rotatably coupled to the retaining mechanism and the locking bar is releasably engageable with the hand knob such that, when the locking bar is engaged with the hand knob, the hand knob is unable to rotate.

Additionally or alternatively, the locking bar is hingeable between a locked position and an unlocked position.

Additionally or alternatively, the locking bar includes a first arm and a second arm, wherein the first arm and the arm are connected by a cross bar.

Additionally or alternatively, the hand knob includes a plurality of indentations.

Additionally or alternatively, when the locking bar is engaged with the hand knob, each of the first arm and the second arm are engaged with a respective one of the plurality of indentations.

Additionally or alternatively, wherein the hand knob includes a plurality of prongs, wherein each of the plurality of prongs includes a plurality of ridges.

Additionally or alternatively, when the locking bar is engaged with the hand knob, the locking bar is engaged with a one of the plurality of prongs and each of the first arm and the second arm is engaged with a respective one of the plurality of ridges of the one of the plurality of prongs.

Additionally or alternatively, each of the plurality of indentations includes a pair of protuberances extending partially across an opening defined by each of the plurality of indentations.

Additionally or alternatively, when each of the first arm and the second arm are engaged with a respective one of the plurality of indentations, the first arm and the second are engaged with a respective one of the pair of protuberances on the respective ones of the plurality of indentations, and wherein each of the protuberances are sized and dimensioned to prevent inadvertent release of the locking bar.

Additionally or alternatively, for any of the above hand knob assemblies, when the locking bar is engaged with the hand knob, the cross bar is above the hand knob. Additionally or alternatively, for any of the above hand knob assemblies, the retaining mechanism includes a support member, the support member having one or more engagement members configured for engagement with a bracket, and a lock retainer.

Additionally or alternatively, the lock retainer couples to the locking bar such that the locking bar is rotatable from a locked position to an unlocked position.

Additionally or alternatively, the locking bar is designed and configured such that the locking bar engages with the lock retainer via tension.

Additionally or alternatively, the locking bar includes a pair of locking bar ends configured to be received by and engage with a pair of corresponding apertures in the support member.

Additionally or alternatively, the support member includes one or more protuberances configured to limit an extent of rotation of the locking bar in the unlocked position.

A method of limiting rotation of a hand knob is provided that includes rotating a hand knob having a threaded member fixedly coupled to the hand knob to a desired position and engaging a locking bar over the hand knob such that the hand knob is unable to rotate.

Additionally or alternatively, the engaging includes rotating the locking bar from an unlocked position to a locked position, wherein in the locked position the locking bar engages with a plurality of indentations of the hand knob.

Additionally or alternatively, the engaging includes rotating the locking bar from an unlocked position to a locked position, wherein in the locked position the locking bar engages with a plurality of ridges on a prong of the hand knob.

Additionally or alternatively, the method includes inserting a pair of ends of the locking bar into a respective pair of apertures in a support member of a retaining mechanism coupled to the hand knob.

Additionally or alternatively, the locking bar includes a cross bar connecting a first arm and a second arm, and wherein the cross bar is above the hand knob when the locking bar is engaged with the hand knob.

Additionally or alternatively, the method includes rotating the locking bar to the unlocked position until the locking bar engages with a stop member on a lock retainer to limit an extent of rotation.

### BRIEF DESCRIPTION OF THE DRAWINGS

For the purpose of illustrating the disclosed embodiments, the drawings show aspects thereof. It is to be understood, however, that the teachings of the present disclosure are not limited to the precise arrangements and instrumentalities shown in the drawings, wherein:

FIG. 1 is a perspective view of a prior art hand knob for a monitor mount;

FIG. 2A is a side perspective view of a hand knob assembly with a retaining mechanism in a locked position and attached to a bracket according to an embodiment of the present invention;

FIG. 2B is a side perspective view of the hand knob assembly of FIG. 2B shown detached from the bracket;

FIG. 2C is a top view the hand knob assembly of FIG. 2A;

FIG. 2D is a front perspective view of the hand knob assembly of FIG. 2A;

FIG. 2E is a top view of a hand knob assembly of FIG. 2A with the retaining mechanism in the unlocked position;

FIG. 3A is a top view of a hand knob assembly with a retaining mechanism in a locked position according to another embodiment of the present invention;

FIG. 3B is a front perspective view of the hand knob assembly of FIG. 3A;

FIG. 3C is a perspective view of the hand knob assembly of FIG. 3A showing a change from the locked position to the unlocked position of the retaining mechanism;

FIG. 4A is a top view of a hand knob assembly with a retaining mechanism in a locked position according to another embodiment of the present invention;

FIG. 4B is a front perspective view of the hand knob assembly of FIG. 4A;

FIG. 4C is an exploded view of the hand knob assembly of FIG. 4A;

FIG. 4D is a perspective view of the hand knob assembly of FIG. 4A showing the retaining mechanism in a locked position; and

FIG. 4E is a perspective view of the hand knob assembly of FIG. 4A showing the retaining mechanism in an unlocked position in which the retaining mechanism is limited by protrusions.

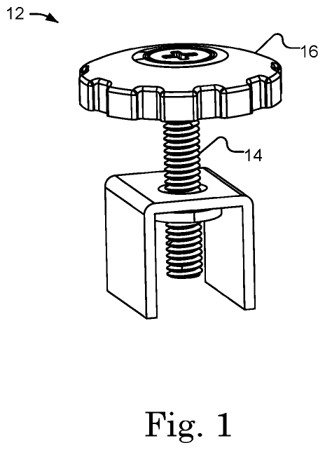

### DETAILED DESCRIPTION

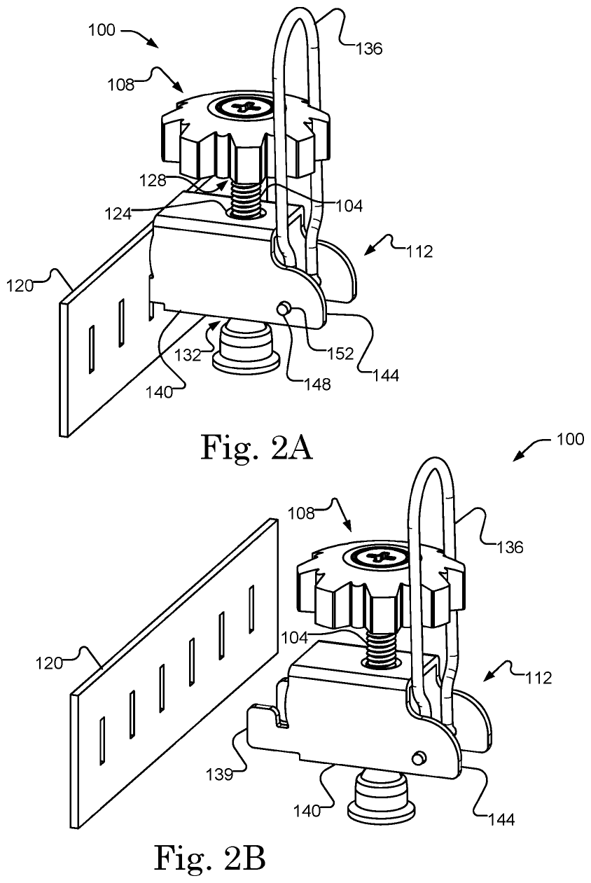

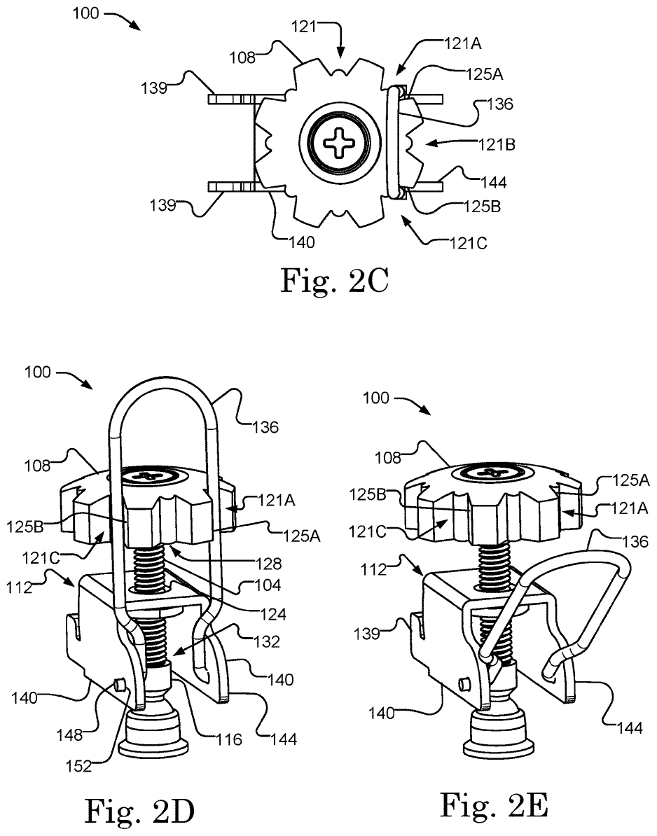

With reference to FIGS. 2A-2E, an exemplary embodiment of a hand knob assembly 100 is shown. Hand knob assembly 100 includes a threaded portion 104, a hand knob 108, a retaining mechanism 112, and a retaining nut 116. In this embodiment, hand knob assembly 100 is releasably coupled to a bracket 120 via a pair of engagement members 139 (e.g., 139A as can be seen in FIG. 2B).

Threaded portion 104 is designed and configured to engage with retaining mechanism 112 via threaded aperture 124. At a proximate end 128 of threaded portion 104 is coupled hand knob 108, such coupling being accomplished by methods known in the art, e.g., attached with a fastener, press fit, form fit, overmolded, and glued. At a distal end 132 (partially obscured) of threaded portion 104, a retaining nut 116 can be included. Retaining nut 116 is designed and configured to thread onto threaded portion 104. Retaining nut 116 prevents the user from fully removing threaded portion 104 from retaining mechanism 112. In certain embodiments, retaining nut 116 is designed and configured to also distribute the mechanical pressure on the material being clamped.

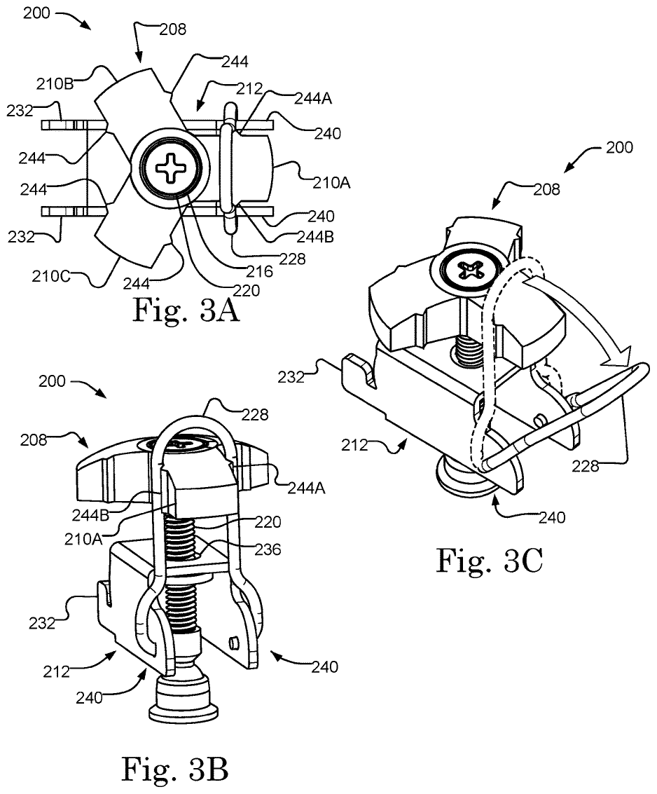

Hand knob 108, as best seen in FIG. 2C, has a plurality of indentations 121 (e.g., 121A-121C) to facilitate rotation and is fixed to threaded portion 104. Various styles and configurations of hand knob 108 are known in the art, such as hand knob 208 (FIG. 3A), wing nut style, ball, t-handle, star, or various thumb screws as described in, for example, U.S. Design Patent No. 816,758 to Martin et al. The design and configuration of hand knob 108 is determined by its ability to receive the lock bar 136 of retaining mechanism 112.

Retaining mechanism 112, as shown in FIGS. 2D-2E, includes a support member 140 and a locking bar 136. Locking bar 136 may include a pair of arms connected by a cross member that is positioned over the hand knob when the locking bar is in the locked position as described below. Support member 140 can include engagement members 139 for engagement with bracket 120, threaded aperture 124, and a lock retainer 144. Lock retainer 144 couples to locking bar 136 such that the locking bar 136 can rotate from a locked position to an unlocked position (an example of the unlocked position is shown in FIG. 2E). In this embodiment, locking bar 136 is designed and configured such that the locking bar engages with lock retainer 144 via tension, whereby the locking bar ends 148 are pressed together to insert and engage with a pair of corresponding apertures 152.

In use, a user rotates hand knob 108 to the desired position and then lifts locking bar 136 until locking bar 136 engages with hand knob 108. Preferably locking bar 136 engages with hand knob 108 such that a portion of locking bar 136 engages with one or more of the plurality of indentations 121. In this configuration, locking bar 136 substantially eliminates further rotation of hand knob 108, thereby maintaining the desired position of threaded portion 104. (As used herein, “unable to rotate” means the knob is substantially held in place without significant rotational movement in the context of what it is securing.) It is noted that in some embodiments, indentations 121 are configured to provide opposing protrusions or catch surfaces 125 (e.g., 125A, 125B). The opposing protrusions or catch surfaces 125 each provide a surface for an interference fit with locking bar 136 when it is engaged with one or more of the plurality of indentations 121, thereby preventing inadvertent release of the locking bar 136 from the knob 108.

Turning now to FIGS. 3A-3C, there is shown another embodiment of a hand knob assembly, hand knob assembly 200. Hand knob assembly 200 functions similarly to hand knob assembly 100 and achieves a similar desired result (substantial elimination of movement of the threaded portion when locked). In contrast to hand knob assembly 100, hand knob assembly 200 has a variation of hand knob and a different configuration of retaining mechanism. Specifically, hand knob assembly 200 includes hand knob 208 and retaining mechanism 212.

Hand knob 208 is a three-pronged knob having an aperture 216 in its center for receiving a bolt 220. Hand knob 208 also includes a plurality of ridges 244 (e.g., 244A, 244B) on each prong 210 (e.g., 210A, 210B, 210C) of the hand knob. Although shown with three prongs 210 and only one set of ridges 244 on each prong, more or fewer prongs and more than one set of ridges per prong could be employed. Ridges 244 are sized and dimensioned to engage with locking bar 228, thereby preventing the inadvertent release of the locking bar when engaged with hand knob 228.

Retaining mechanism 212 may include engagement members 232 (for engagement with a bracket, such as bracket 120 of FIG. 2A), a threaded aperture 236 for receiving bolt 220 (which, in some embodiments, is at least partially threaded like threaded portion 104), locking bar 228, and lock retainer 240. Lock retainer 240 and lock bar 228 are cooperatively designed and configured to allow for rotational movement of lock bar 228 (FIG. 3C). In certain embodiments a riveting attachment (not shown) can couple retainer 240 to lock bar 228.

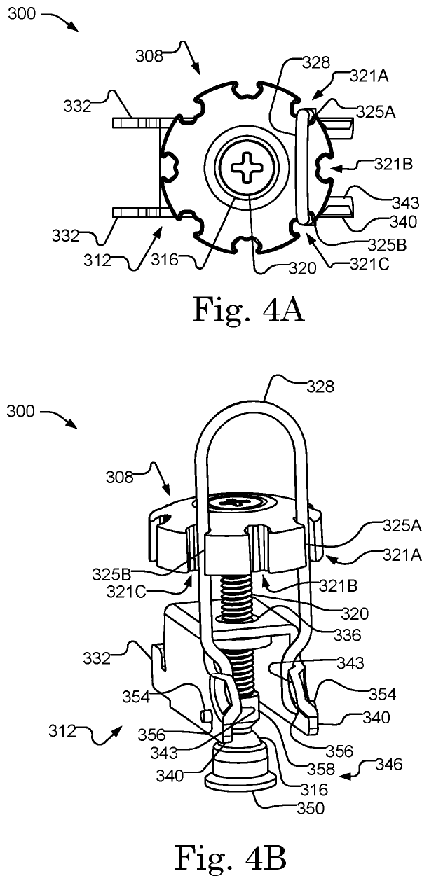

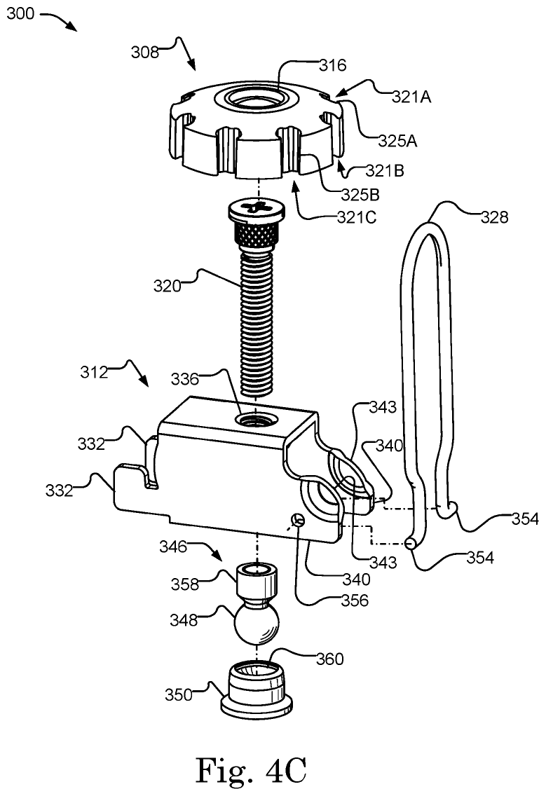

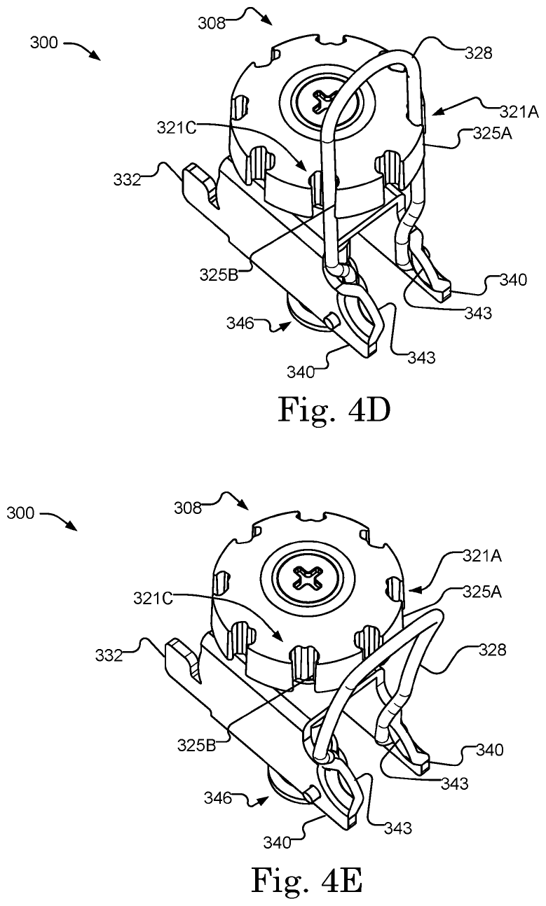

Turning now to FIGS. 4A-4E, there is shown another embodiment of a hand knob assembly, hand knob assembly 300. Hand knob assembly 300 includes a hand knob 308 with an aperture 316 in its center for receiving a bolt 320. A retaining mechanism 312 and functions similarly to hand knob assemblies 100 and 200, achieving a similar desired result (substantial elimination of movement of the threaded portion when locked). Retaining mechanism 312 includes engagement members 332 (for engagement with a bracket, such as bracket 120 of FIG. 2A), a threaded aperture 336 for receiving bolt 320 (which, in some embodiments, is at least partially threaded like threaded portion 104), locking bar 328, and lock retainer 340. Lock retainer 340 and lock bar 328 are cooperatively designed and configured to allow for rotational movement of lock bar 328 (FIGS. 4D-4E).

Hand knob assembly 300 includes indentations 321 (e.g., 321A-321C) having protuberances 325 (e.g., 325A, 325B) extending from the outer edges of indentations 321 partially across the opening defined by the indentations. Indentations 321 are configured to receive arms of locking bar 328 and protuberances 325 are configured to releasably hold the arms of locking bar 328 in indentations 321. Indentations 321 and protuberances 325 are sized and dimensioned to engage with locking bar 328, thereby preventing the inadvertent release of the locking bar when engaged with hand knob 328 and eliminating rotation of knob 308. In this embodiment, pair of ends 354 (as best seen in FIG. 4C) of locking bar 328 are configured to be received into a respective pair of apertures 356 in lock retainer 340, which further includes one or more stop members or protrusions 343 positioned such that when locking bars 328 are rotated from the locked position to the unlocked position, the travel of locking bars 328 is limited (a shown in FIG. 4E).

In addition, as can be seen in FIG. 4C, a clamping mechanism 346 may be attached to receiving bolt 320 that includes a retaining nut 358 formed with a ball end 348 and a foot 350 that includes a rounded cavity 360 for receiving the ball end 348 and enabling rotational movement of the foot 350 relative to the ball end 348 when they are assembled together.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure.

Accordingly, this description is meant to be taken only by way of example, and not to otherwise limit the scope of this disclosure.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

1. A hand knob assembly comprising:
a hand knob;
a threaded member fixedly coupled to the hand knob; and
a retaining mechanism including a locking bar, wherein the threaded member is rotatably coupled to the retaining mechanism and the locking bar is releasably engageable with the hand knob such that, when the locking bar is engaged with the hand knob, the hand knob is unable to rotate.

2. The hand knob assembly of claim 1, wherein the locking bar is hingeable between a locked position and an unlocked position.

3. The hand knob assembly of claim 1, wherein the locking bar includes a first arm and a second arm, wherein the first arm and the second arm are connected by a cross bar.

4. The hand knob assembly of claim 3, wherein the hand knob includes a plurality of indentations.

5. The hand knob assembly of claim 4, wherein, when the locking bar is engaged with the hand knob, each of the first arm and the second arm are engaged with a respective one of the plurality of indentations.

6. The hand knob assembly of claim 3, wherein the hand knob includes a plurality of prongs, wherein each of the plurality of prongs includes a plurality of ridges.

7. The hand knob assembly of claim 6, wherein, when the locking bar is engaged with the hand knob, the locking bar is engaged with a one of the plurality of prongs and each of the first arm and the second arm is engaged with a respective one of the plurality of ridges of the one of the plurality of prongs.

8. The hand knob assembly of claim 5, wherein each of the plurality of indentations includes a pair of protuberances extending partially across an opening defined by each of the plurality of indentations.

9. The hand knob assembly of claim 8, wherein, when each of the first arm and the second arm are engaged with a respective one of the plurality of indentations, the first arm and the second are engaged with a respective one of the pair of protuberances on the respective ones of the plurality of indentations, and wherein each of the protuberances are sized and dimensioned to prevent inadvertent release of the locking bar.

10. The hand knob assembly of claim 4, wherein when the locking bar is engaged with the hand knob, the cross bar is above the hand knob.

11. The hand knob assembly of claim 4, wherein the retaining mechanism includes a support member, the support member having one or more engagement members configured for engagement with a bracket, and a lock retainer.

12. The hand knob assembly of claim 11, wherein the lock retainer couples to the locking bar such that the locking bar is rotatable from a locked position to an unlocked position.

13. The hand knob assembly of claim 12, wherein the locking bar is designed and configured such that the locking bar engages with the lock retainer via tension.

14. The hand knob assembly of claim 13, wherein the locking bar includes a pair of locking bar ends configured to be received by and engage with a pair of corresponding apertures in the support member.

15. The hand knob assembly of claim 14, wherein the support member includes one or more protuberances configured to limit an extent of rotation of the locking bar in the unlocked position.

16. A method for limiting rotation of a hand knob comprising:
rotating a hand knob having a threaded member fixedly coupled to the hand knob to a desired position; and
engaging a locking bar over the hand knob such that the hand knob is unable to rotate.

17. The method of claim 16, wherein the engaging includes rotating the locking bar from an unlocked position to a locked position, wherein in the locked position the locking bar engages with a plurality of indentations of the hand knob.

18. The method of claim 16, wherein the engaging includes rotating the locking bar from an unlocked position to a locked position, wherein in the locked position the locking bar engages with a plurality of ridges on a prong of the hand knob.

19. The method of claim 16, further including inserting a pair of ends of the locking bar into a respective pair of apertures in a support member of a retaining mechanism coupled to the hand knob.

20. The method of claim 19, wherein the locking bar includes a cross bar connecting a first arm and a second arm, and wherein the cross bar is above the hand knob when the locking bar is engaged with the hand knob.

21. The method of claim 17, further including rotating the locking bar to the unlocked position until the locking bar engages with a stop member on a lock retainer to limit an extent of rotation.
